(19) United States
(12) Patent Application Publication
(10) Pub. No.: US 2009/0094995 A1
(43) Pub. Date: Apr. 16, 2009

(54) SYSTEM AND METHOD FOR PROCESSING FOOD PRODUCTS WITH FLUID RECIRCULATION AND CHILLING

(75) Inventor: David C. Braithwaite, Katy, TX (US)

Correspondence Address: AIR LIQUIDE;Intellectual Property, 2700 POST OAK BOULEVARD, SUITE 1800, HOUSTON, TX, 77056, US

(73) Assignee: Air Liquide Industrial U.S. LP, Houston, TX (US)

(21) Appl. No.: 12/102,627

(22) Filed: Apr. 14, 2008

Related U.S. Application Data
(63) Continuation-in-part of application No. 11/763,005, filed on Jun. 14, 2007.
(60) Provisional application No. 60/813,940, filed on Jun. 15, 2006.

(51) Int. Cl. A23L 3/36; A23L 3/375; F25D 3/11

(52) U.S. Cl. 62/63; 165/104.19; 165/287; 165/157

(57) ABSTRACT

Systems and methods freeze food products. A system provides a storage tank of liquefied gas, a gas-liquid separation tank, and a crust freezer. The crust freezer provides plates chilled by flow of liquefied gas through conduits traversing an interior volume of the plates. The method includes recirculating liquefied gas to improve cooling efficiency while lowering operation costs. The system and method further provide for integrated measurement and control of the flow of liquefied gas through components of the system. Freezing of the food products occurs at a surface of the food products along where the food products and the plate interface.

### CROSS-REFERENCE TO RELATED APPLICATIONS

This application is a continuation-in-part of U.S. patent application Ser. No. 11/763,005 filed on Jun. 14, 2007, and which claims benefit to provisional application No. 60/813,940, filed Jun. 15, 2006. The entire contents of each aforementioned application are incorporated herein by reference.

### BACKGROUND

Various approaches exist for freezing food products. The food products often pass over some form of “crusting table” to freeze bottom surfaces of the food products such that the food products can subsequently travel on belts or conveyors through additional freezing equipment. Without freezing the bottom surfaces first, the food products with soft and/or wet outer surfaces supported by the belt may stick to the belt leaving remnants that must be removed prior to continued use of the belt. Further, the belt may leave undesirable marks on the food products if the bottom surfaces are not frozen before the food products are placed on the belt.

### SUMMARY

Embodiments of the invention relate to devices and methods for freezing food products. One embodiment provides a refrigeration liquid recirculation system for chilling the food products. The system includes a chilling plate that has a fluid passageway traversing an interior volume thereof between an inlet and an outlet of the fluid passageway and a food contact surface for thermally contacting the food products to freeze at least a surface of the food products thermally interfacing with the chilling plate. The system further includes a source of liquefied gas fluidly coupled to the inlet of the fluid passageway via a supply line and coupled to the outlet of the fluid passageway via a return line such that the food contact surface is temperature controlled by flowing the liquefied gas through the fluid passageway.

In one embodiment, a refrigeration liquid recirculation system for chilling food products includes a chilling plate having an interior volume that defines a fluid passageway connecting an inlet into the plate and an outlet from the plate. The chilling plate includes a food support surface for thermally contacting the food products to freeze at least a surface of the food products that interfaces with the chilling plate. Further, the system includes a source of refrigeration liquid fluidly coupled to the inlet and the outlet to define a circulation loop. A pump of the system disposed along the circulation loop maintains temperature of the chilled plate below −129° C. based on flow of the refrigeration liquid.

For one embodiment, a method of chilling food products includes circulating a liquefied gas through a circulation loop. The circulating includes flowing the liquefied gas from a source of the liquefied gas to an inlet of a chilling plate, flowing the liquefied gas through the chilling plate, whereby the chilling plate is cooled, removing the liquefied gas from an outlet of the chilling plate, and flowing the liquefied gas that is removed back to the source. The method additionally includes disposing the food products on the chilling plate, thereby freezing the food products at a surface of the food products along where the food products and the plate interface

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 illustrates schematic components of an exemplary recirculation system that enables freezing of food products, in accordance with embodiments of the invention;

FIG. 2A illustrates part of the system with first and second chilling plates between which the food products are conductively frozen and optionally reshaped by compressive forces applied by the plates, in accordance with embodiments of the invention;

FIG. 2B illustrates an alternative circuitous flow path for liquefied gas through one of the chilling plates, in accordance with embodiments of the invention;

FIG. 3 illustrates both of the chilling plates in use freezing and flattening the food products, in accordance with embodiments of the invention; and

FIG. 4 illustrates use of one of the chilling plates in combination with a finishing freezer of the system, in accordance with embodiments of the invention.

FIG. 5 illustrates another system with a chilling plate and a shower assembly that has orifices facing a support surface of the chilling plate to direct chilled vapor toward the chilling plate within an enclosure, in accordance with embodiments of the invention.

### DESCRIPTION OF PREFERRED EMBODIMENTS

The time required for food products to be on a cooling surface (e.g., “crusting table”) and hence the length of the surface corresponds to how cold the surface is able to be maintained. The crusting tables may be chilled with refrigerants such as fluorocarbons, but such refrigerants may only provide chilling to about −40° C. Alternatively, systems may utilize expensive liquid nitrogen to achieve lower temperatures by introducing the liquid nitrogen through channels in a plate of the table. However, the liquid nitrogen may vaporize as it passes to an outlet for the channels, thereby reducing cooling efficiency, increasing the cost of operation of the system due to consumption of the nitrogen that exits the outlet as gas, and limiting a lowest temperature achievable.

Embodiments of the invention provide devices and methods for freezing and optionally shaping food products and/or storing frozen food products. In such embodiments liquefied gas is recirculated. Conduction between the food products and plates in communication with the liquefied gas being circulated freezes at least an outer surface of the food products.

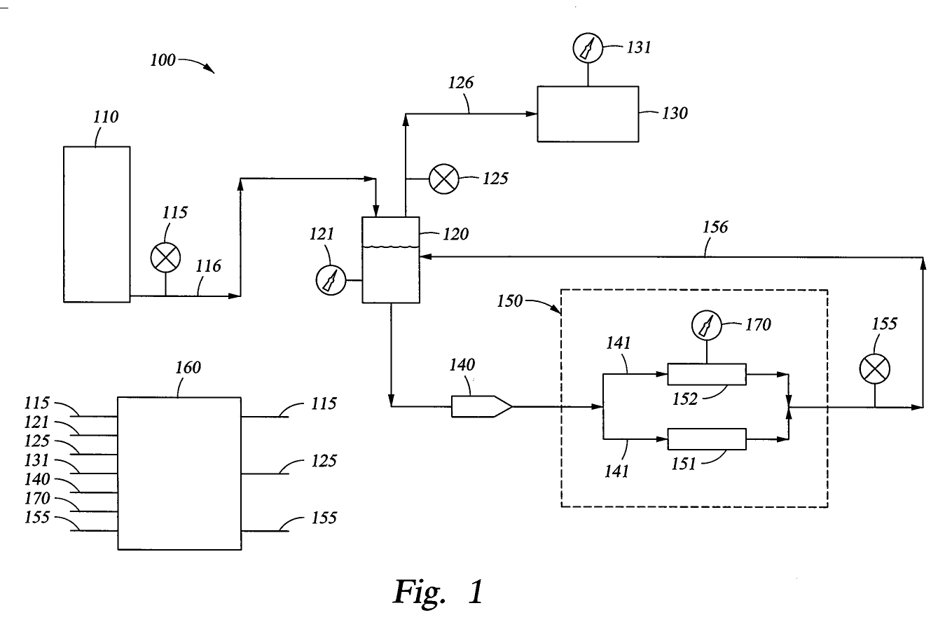

FIG. 1 illustrates one embodiment of an exemplary liquefied gas recirculation system 100. As depicted, the recirculation system provides a circuit for the flow of liquefied gas, whereby liquefied gas may be provided from a source, to a point of use and then recirculated back to the source. It should be appreciated that the recirculation system 100 may include any number of inlets and outlets, e.g., to provide improved performance. It should also be appreciated that a secondary refrigerant, such as d-limonene, could be used in place of or in conjunction with (either mixed with or isolated from) the recirculated liquefied gas. The secondary refrigerant may be mechanically or cryogenically chilled and may include any liquid that is capable of being chilled to below −73° C., for example. For improved cooling efficiency, any or all of the components of the liquefied gas recirculation system 100 may be insulated from external temperatures, such as through the use of vacuum jackets or urethane coatings.

In one embodiment of the invention, a storage tank 110 may provide a reservoir of liquefied gas. It should be appreciated by those skilled in the art that any one of a number of liquefied gases could be selected, including gases such as nitrogen, helium, argon or carbon dioxide, depending on the target temperature requirements. For the purposes of illustration and without limitation, in this example, nitrogen is utilized as the recirculated liquefied gas. The rate of flow of a first liquid nitrogen stream 116 from the storage tank 110 may be controlled by a first flow control valve 115. The first liquid nitrogen stream 116 may be introduced into a gas-liquid separation tank 120. The amount of liquid nitrogen contained in the gas-liquid separation tank 120 may be measured by a load cell or other liquid content measurement device 121. In one embodiment, the first flow control valve 115 and the liquid content measurement device 121 may communicate with a control device 160 to provide integrated measurement and control of the amount of liquid nitrogen introduced into the gas-liquid separation tank 120.

The gas-liquid separation tank 120 may serve as a reservoir of nitrogen vapor for a cryogenic storage or freezer unit such as a finishing freezer 130 that may be a spiral or tunnel type of freezer. The rate of flow of a nitrogen vapor stream 126 may be controlled by a second flow control valve 125. The temperature of the finishing freezer 130 may be measured by a first temperature measurement device 131. In one embodiment, the second flow control valve 125 and the first temperature measurement device 131 may communicate with the control device 160 to provide integrated measurement and control of the amount of nitrogen vapor introduced into the finishing freezer 130.

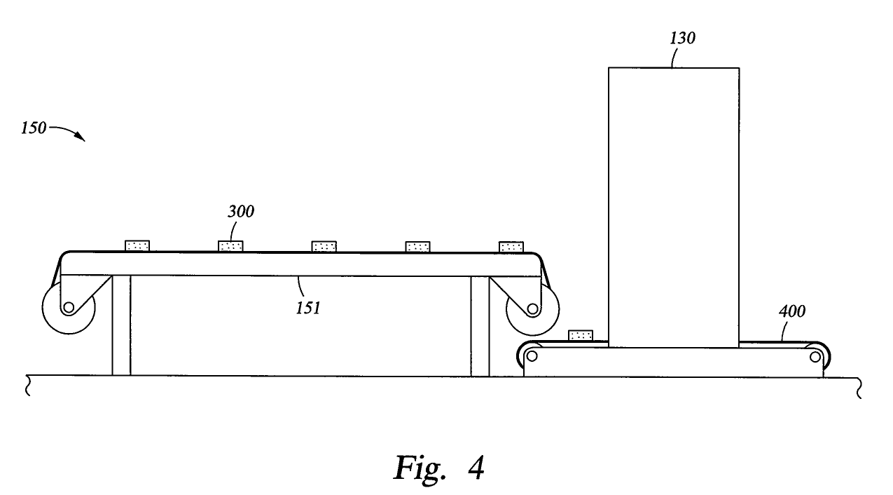

The gas-liquid separation tank 120 may also serve as a recirculation reservoir for a crust freezer 150. A second liquid nitrogen stream 141 may be drawn from the gas-liquid separation tank 120 by a pump 140. The second liquid nitrogen stream 141 may then traverse first and second freezing plates 151, 152, thereby providing cryogenic convective-conductive cooling of the plates 151, 152. The system 100 may include only the first freezing plate 151 without the second freezing plate 152 for some embodiments, such as shown in FIG. 4. While the nitrogen vapor stream 126 may be at −101° C., the second liquid nitrogen stream 141 that may be at −184° C. provides relatively more cooling ability according to one embodiment. The freezing plates 151, 152 may be made of a heat-conductive material, such as aluminum, carbon steel, or stainless steel. A resultant liquid nitrogen/nitrogen vapor stream 156 may be returned to the gas-liquid separation tank 120.

In some embodiments, the second liquid nitrogen stream 141 stays at least 50% in liquid phase while passing through the plates 151, 152 such that the resultant liquid nitrogen/nitrogen vapor stream 156 contains less than 50% vapor. The second liquid nitrogen stream 141, due to the liquid phase within the plates 151, 152, provides improved heat transfer with the plates 151, 152 relative to heat transfer with vapor. Rate of flow for the liquid nitrogen/nitrogen vapor stream 156 exiting the crust freezer 150 may be controlled by a third flow control valve 155. Operation of the pump 140 and/or the third flow control valve 155 passes the second liquid nitrogen stream 141 sufficiently fast, as made feasible due to the recirculation, through the plates 151, 152 to achieve the second liquid nitrogen stream 141 staying at least 50% liquid upon exiting the plates 151, 152.

The temperature of the crust freezer 150 and/or food products may be monitored by a second temperature measurement device 170. In one embodiment, the pump 140, the third flow control valve 155, and the second temperature measurement device 170, may communicate with the control device 160 to provide integrated measurement and control of the residence time of nitrogen in the freezing plates 151, 152, thereby controlling the temperature of the crust freezer 150. It should be appreciated that the locations of the pump 140 and the third flow control valve 155 are interchangeable. Although FIG. 1 shows the second temperature measurement device 170 directly connected to the second freezing plate 152, it should be appreciated that a variety of other configurations would provide appropriate measurements of the temperature of the crust freezer 150. In one embodiment, the temperature for the plates 151, 152 of the crust freezer 150 may be maintained within a range of −129° C. to −173° C. Throughput may increase per unit length of the plates 151, 152 as the temperature of the plates 151, 152 is lowered.

Although the streams 116, 126, 141, 156 are illustrated as individual streams, it should be understood that portions of each stream may be removed for other purposes not shown in FIG. 1. For example, all or some of the nitrogen vapor stream 126 may be used to cool an atmosphere around the plates 151, 152. For some embodiments, the finishing freezer 130 may be omitted such that the nitrogen vapor stream 126 may be vented or liquefied by cooling and compressing prior to returning to the storage tank 110. At least the liquid nitrogen streams 116, 141, the liquid nitrogen/nitrogen vapor stream 156 and passage through the crust freezer 150, may together define a sealed or closed environment preventing loss of nitrogen.

In one embodiment, the control device 160 continuously communicates with the flow control valves 115, 125, 155, the liquid content measurement device 121, the temperature measurement devices 131, 170, and the pump 140 to provide integrated measurement and control of all aspects of the liquefied gas recirculation system 100. In an alternative embodiment, the control device 160 communicates sequentially with the various components as necessitated by the production process.

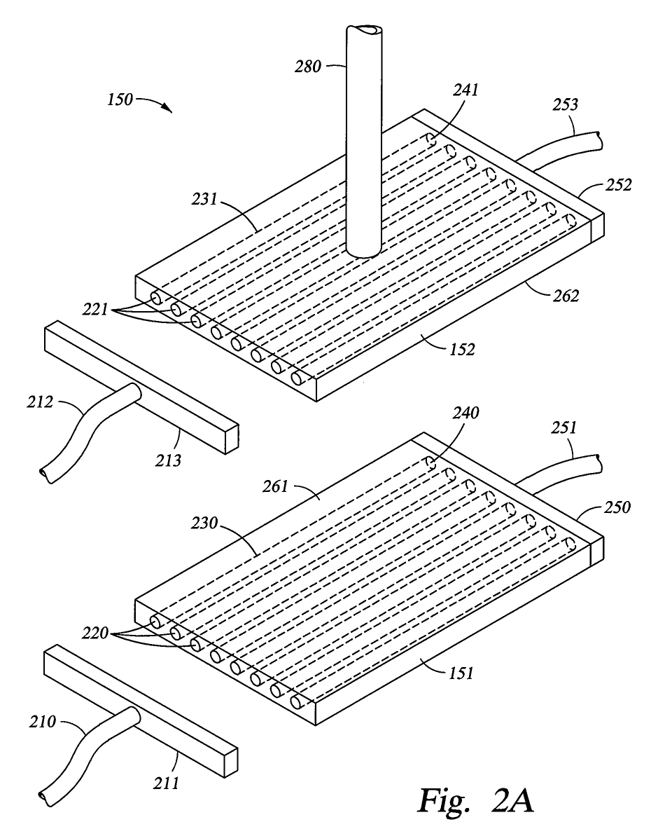

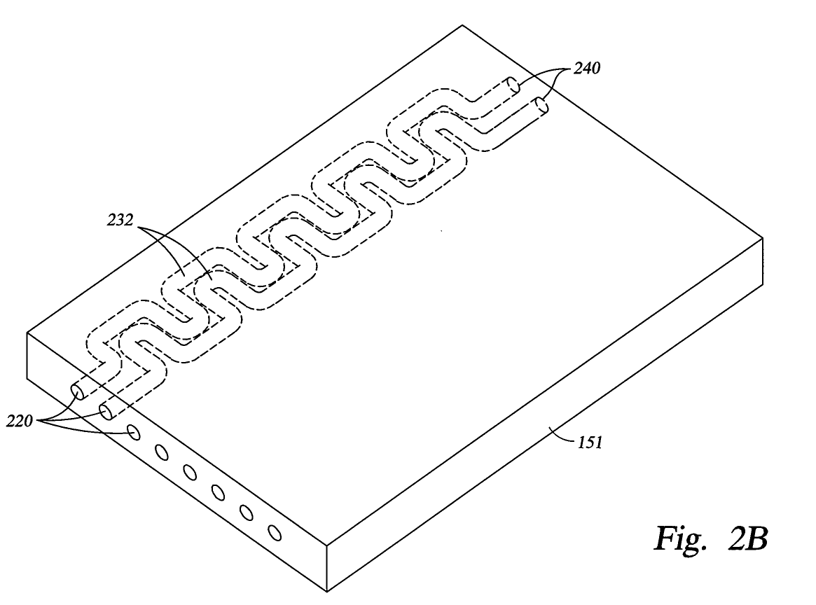

FIG. 2A illustrates one example of the crust freezer 150. The second liquid nitrogen stream 141 may enter the crust freezer 150 through flexible first and second input tubing 210, 212, which may be connected respectively to the first and second freezing plates 151, 152 via first and second input manifolds 211, 213, respectively. The second liquid nitrogen stream 141 may be divided into a plurality of streams by the input manifolds 211, 213 for respective introduction into first and second plurality of inlet holes 220, 221. Liquid nitrogen may flow through the first and second plurality of inlet holes 220, 221 into respective first and second plurality of conduit passageways 230, 231, which may traverse the volume of the freezing plates 151, 152. Although FIG. 2A illustrates straight conduit passageways 230, 231, it should be appreciated that the conduit passageways 230, 231 could follow curved trajectories to provide for longer path length, thereby greater residence time for any given flow rate. An example of a possible curved trajectory conduit path 232 is illustrated in FIG. 2B. It should also be appreciated that while bore diameters may be constant across the length of the conduit passageways 230, 231, the bore diameters may also vary across the length of the conduit passageways 230, 231 to permit flow concentration at certain locations. A mixture of liquid nitrogen and nitrogen vapor may exit the conduit passageways 230, 231 through respective first and second plurality of outlet holes 240, 241. First and second output manifolds 250, 252 facilitate coalescing of exiting streams into the liquid nitrogen/nitrogen vapor stream 156, which flows out of the crust freezer 150 through flexible first and second output tubing 251, 253 coupled respectively to the first and second output manifolds 250, 252.

Although FIG. 2A illustrates the first input manifold 211, for example, as a single (unitary) structure, it should be appreciated that each of the first plurality of inlet holes 220 may be individually connected to flexible first input tubing 210 via a connection substructure of a manifold assembly. The individual connections may be CGA-295 cryogenic fittings, dissimilar metal bayonet connections or other cryogenic fittings commonly known in the art. Additionally, it should be appreciated that the tubing 210, 212, 251, 253 may be constructed from a variety of cryogenic hoses known in the art, including both flexible and fixed transfer hoses.

While FIG. 2A shows each of the first plurality of inlet holes 220, for example, breaching the perimeter of the first freezing plate 151 from only one side, it should be appreciated that the first plurality of inlet holes 220 may exist on multiple sides of the first freezing plate 151. For example, in one embodiment, gas flows in opposite directions in adjacent ones of the first plurality of conduit passageways 230, necessitating alternating the first plurality of inlet holes 220 and first plurality of outlet holes 240 on one side of the first freezing plate 151. One skilled in the art will appreciate that the temperature at specified points on the first freezing plate 151 can be more precisely controlled by customizing the configuration of the first plurality of conduit passageways 230 and the direction of gas flow through each of the first plurality of conduit passageways 230. Similar variations may occur in configuration and flow direction for the second plurality of conduit passageways 231 within the second freezing plate 152.

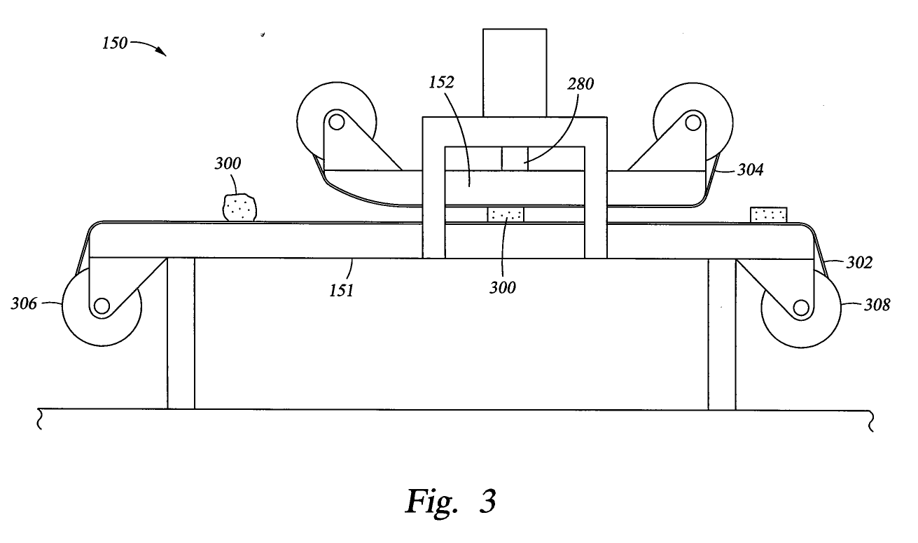

FIG. 3 shows one embodiment of the crust freezer 150 in use with food products 300 being inserted between the freezing plates 151, 152, which may or may not enclose the food products 300. Examples of the food products 300 include meats, fruits, vegetables, solid products and liquid products. An outer surface of the food products 300 freezes due to heat transfer with the plates 151, 152. Instead of just being frozen at the outer surface, the food products 300 may freeze throughout while on the crust freezer 150. Variables that may be adjusted to control to what extent the food products 300 freeze while on the crust freezer 150 include thermal contact time between the food products 300 and the freezing plates 151, 152, temperature of the freezing plates 151, 152, and/or percentage of the food products 300 in contact with the freezing plates 151, 152. For example, an interval between when the food products 300 are disposed on the crust freezer 150 and subsequently removed from the crust freezer 150 may vary based on length of the freezing plates 151, 152 and/or speed in which the food products 300 are conveyed across the freezing plates 151, 152. In addition, mold shapes within the plates 151, 152 for liquid forms of the food products 300 or shaping of the food products as discussed hereinafter may facilitate controlling what percentage of the food products 300 is frozen while on the crust freezer 150 since making the food products 300 thinner can increase thermally interfacing surface area relative to volume of the food products 300 and hence the extent of freezing of the food products 300.

Pressure may be applied to the freezing plates 151, 152 by a pressure source 280, which creates the pressure by moving the plates with actuation or gravity relative to one another or holding the plates 151, 152 a fixed distance apart while the food products 300 larger than the fixed distance are forced between the plates 151, 152. For example, the pressure source 280 in one embodiment defines a piston coupled to the second freezing plate 152 at one end and an actuator 380 at another end. The actuator 380 fixed relative to the first freezing plate 151 may be under operation of the control device 160. The control device 160 may periodically raise and lower the second freezing plate 152 corresponding to when subsequent one or more of the food products 300 pass between the plates 151, 152 during use. For some embodiments, the actuator 380 enables adjustment and selection of the fixed distance that the plates 151, 152 are maintained apart during feeding of the food products 300 in between the plates 151, 152. If gravity creates the pressure, the second freezing plate 152 may hang via the pressure source 280 in a free sliding relationship above the first freezing plate 151 such that weight of the second freezing plate 152 itself urges the second freezing plate 152 toward the first freezing plate 151.

This application of pressure may cause the food products 300 to be compressed and/or change shape against flat and parallel first and second thermally conductive surfaces 261, 262 (visible in FIG. 2A) of respectively the first and second freezing plates 151, 152. For example, flattening of the food products 300 facilitates even freezing and cooking. Further, reshaping of the food products 300 to standard shapes may allocate portions or aid in portion control or packaging. Although shown with the pressure source 280 working directly on the second freezing plate 152, it should be appreciated that pressure could be applied to either or both of the freezing plates 151, 152.

The freezing of the food products 300 occurs at least partially as a result of contact, either direct or indirect without intervening gas convection, of the food products 300 with the conductive surfaces 261, 262 of the freezing plates 151, 152. For some embodiments, a consumable first film 302 covers the first freezing plate 151 with the food products 300 supported by the first freezing plate 151 being disposed on the first film 302. In operation, the first film 302 unwinds off an input roll 306 across the first freezing plate 151 and is recovered by a take-up roll 308 that is driven such the first film 302 acts to move the food products 300 along the first freezing plate 151. The second freezing plate 152 may utilize a consumable second film 304 in a similar manner. Suitable materials for the films 302, 304 include plastics such as polyethylene. It should be understood that the food products 300 may be initially placed on the table and/or subsequently removed by manual acts, robotics, or passage from/to other conveyors. For example, the food products 300 may drop off of the first freezing plate 151 into packaging such as boxes suitable for storage and transport.

FIG. 4 illustrates use of the crust freezer 150 with the first freezing plate 151 in combination with the finishing freezer 130. Bottom surfaces of the food products 300 are sufficiently chilled (e.g., frozen) while on the first freezing plate 151. In operation, the food products 300 move across the first freezing plate 151 toward the finishing freezer 130. While not repeated for conciseness, such conveyance of the food products 300 may utilize techniques such as already described herein with respect to FIG. 3 and the first film 302. Upon reaching an end of the first freezing plate 151 the food products 300 fall or transfer onto a belt 400 that passes through the finishing freezer 130. As a result of the bottom surface being frozen, the food products 300 can travel on the belt 400 of the finishing freezer 130 without problems of sticking or marking of the food products 300. The finishing freezer 130 completes freezing of the food products 300 that are carried into, through and out of the finishing freezer 130 via the belt 400. Once exited from the finishing freezer 130, the food products 300 may undergo packaging and/or be taken away for storage and transport.

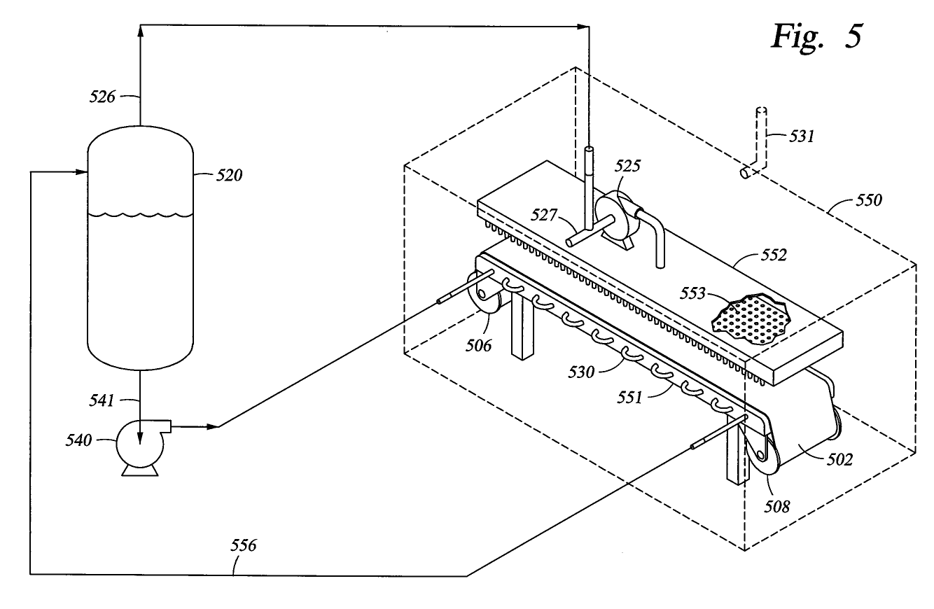

FIG. 5 shows a chilling plate 551 (e.g., analogous to the plate 151 described herein, according to one embodiment) disposed in a tunnel arrangement, for some embodiments. The arrangement may include an enclosure 550 housing the chilling plate 551 and a shower assembly 552 that has orifices 553 facing a support surface of the chilling plate 551. The orifices 553 direct chilled fluid toward the chilling plate 551 such that flow of the chilled fluid is brought into proximity or contact with the food products supported on the chilling plate 551 to effect heat exchange between the food products and the chilled fluid sufficient to facilitate chilling or freezing of the food products. The enclosure 550 includes an exhaust 531 for discharge or recovery of the chilled fluid expelled from the orifices 553 and contained by the enclosure 550.

For some embodiments, a phase separator 520 contains liquefied gas, such as liquid nitrogen, and provides the chilling fluid in the form of vapor or gaseous nitrogen to the shower assembly 552 through a shower input conduit 526. The shower assembly 552 forms a hollow housing that may extend over part or all of the chilling plate 551 to define a plenum in communication with the orifices 553 that extend through a wall of the housing. In some embodiments, the orifices 553 may be disposed 0.3 meters or less above the chilling plate 551. The shower assembly 552 may include the orifices 553 dispersed over the chilling plate 551 since many small columns of gas provide better heat transfer than an undivided flow of the gas. In some embodiments, a density of the orifices 553 is selected such that there are at least 5 of the orifices 553 per square foot. The temperature of gas or gasses from the shower input conduit 526 may be at or below −129° C.

A shower pump 525 pressurizes the chilling fluid in the shower assembly 552 providing a pressure differential with higher pressure inside the shower assembly 552 than out. The shower pump 525 receives input from the shower input conduit 526 and from an ambient intake 527 disposed within the enclosure 550 to in part recycle the chilled fluid back through the shower assembly 552. Due to the ambient intake 527, the shower pump 525 can create the pressure differential using vapor vented from the phase separator 520 with or without drawing additional vapor/liquid from the phase separator 520. The pressure differential creates jetting through the orifices 553 that may be formed in nozzles that extend from the shower assembly 552 or flush apertures through the wall of the shower assembly 552. A spray pattern from each of the orifices 553 may provide a cylindrical, linear, or conical pattern, for example, that may be separated or overlapped upon reaching the chilling plate 551 with spray from an adjacent one of the orifices 553. In some embodiments, a diffuser at a base of the input conduit 526 that terminates in the interior volume of the shower assembly 552 may facilitate uniform distribution of gas in the interior volume.

The chilling plate 551 couples to the phase separator 520 via a supply conduit 541 and a return conduit 556. A plate pump 540 disposed along the supply conduit 541 passes liquid nitrogen (e.g., at or below −184° C.) from the phase separator 520 through passageways 530 in the chilling plate 551 prior to recirculation back to the phase separator 520 through the return conduit 556. A film 502 stretches across the chilling plate 551 from a supply roll 506 of the film to a driven uptake roll 508 of the film. In operation, chilling of the food products supported on the chilled plate 551 and carried by movement of the film 502 occurs simultaneously from conductive contact with the chilled plate 551 and flow from the shower assembly 552 of the chilled fluid brought into proximity or contact with the food products. The food products may be completely frozen upon exiting the enclosure 550 at the uptake roll 508 such that the food products are ready for packaging or shipping.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

What is claimed is:

1. A refrigeration liquid recirculation system for chilling food products, comprising:
a chilling plate, comprising:
a fluid passageway traversing an interior volume of the chilling plate between an inlet and an outlet of the fluid passageway; and
a food contact surface for thermally contacting the food products to freeze at least a surface of the food products thermally interfacing with the chilling plate; and
a source of liquefied gas fluidly coupled to the inlet of the fluid passageway via a supply line and coupled to the outlet of the fluid passageway via a return line; the food contact surface being temperature controlled by flowing the liquefied gas through the fluid passageway.

2. The system of claim 1, wherein the liquefied gas is one of liquefied nitrogen, liquefied helium, liquefied argon and liquefied carbon dioxide.

3. The system of claim 1, further comprising a shower assembly with orifices directed toward the chilling plate, wherein the orifices are in fluid communication with a vapor outlet for the source of liquefied gas.

4. The system of claim 1, further comprising an opposing plate in facing relation to the chilling plate, the opposing plate being cooled and arranged relative to the chilling plate to supply pressure to the food products disposable between the plates.

5. The system of claim 4, wherein the opposing plate includes a fluid input from the source of liquefied gas and a fluid output back to the source of liquefied gas.

6. The system of claim 4, wherein the opposing and chilling plates each have flat surfaces that are parallel and facing one another.

7. The system of claim 4, wherein the opposing and chilling plates are moveable relative to one another.

8. The system of claim 1, further comprising a finishing freezer cooled by exhausted liquefied gas vapor from the source of liquefied gas.

9. The system of claim 1, further comprising a consumable film movable across the chilling plate to convey the food products on the chilling plate.

10. The system of claim 1, further comprising:
a pump fluidly coupled to one of the supply line and the return line;
a control valve fluidly coupled one of the supply line and the return line; and
a temperature measurement device coupled to the chilling plate.

11. The system of claim 10, further comprising a control device in communication with the pump, the control valve, and the temperature measurement device to regulate temperature of the chilling plate.

12. The system of claim 1, further comprising a pump coupled to one of the supply line and the return line and operable to maintain temperature of the chilling plate below −129° C. based on flow of the liquefied gas.

13. A refrigeration liquid recirculation system for chilling food products, comprising:
a chilling plate having an interior volume that defines a fluid passageway connecting an inlet into the plate and an outlet from the plate, wherein the chilling plate has a food support surface for thermally contacting the food products to freeze at least a surface of the food products that interfaces with the chilling plate;
a source of refrigeration liquid fluidly coupled to the inlet and the outlet to define a circulation loop; and
a pump disposed along the circulation loop and operable to maintain temperature of the chilling plate below −129° C. based on flow of the refrigeration liquid.

14. The system of claim 13, wherein the refrigeration liquid is one of liquefied nitrogen, liquefied helium, liquefied argon and liquefied carbon dioxide.

15. A method of chilling food products, comprising:
circulating a liquefied gas through a circulation loop, the circulating comprising:
flowing the liquefied gas from a source of the liquefied gas to an inlet of a chilling plate;
flowing the liquefied gas through the chilling plate, whereby the chilling plate is cooled;
removing the liquefied gas from an outlet of the chilling plate; and
flowing the liquefied gas that is removed back to the source; and
disposing the food products on the chilling plate, thereby freezing the food products at a surface of the food products where the food products and the plate interface.

16. The method of claim 15, wherein the liquefied gas is one of nitrogen, helium, argon and carbon dioxide.

17. The method of claim 15, further comprising introducing chilled gas from a vapor outlet for the source of liquefied gas into contact with the food products disposed on the chilling plate to effect heat exchange between the food products and the chilled gas.

18. The method of claim 15, wherein the liquefied gas that is removed back to the source is at least 50% in liquid phase.

19. The method of claim 15, further comprising reshaping the food products with an opposing plate that is cooled.

20. The method of claim 19, wherein the reshaping of the food products includes moving the chilling plate and the opposing plate relative to one another.

21. The method of claim 15, further comprising:
cooling a finishing freezer utilizing exhausted liquefied gas vapor from the source of liquefied gas; and
passing the food products through the finishing freezer.

22. The method of claim 15, further comprising:
monitoring temperature of the chilling plate; and
controlling flow rate of the liquefied gas that is circulating to maintain temperature of the chilling plate to a specified temperature range.
